(19) United States
(12) Patent Application Publication
(10) Pub. No.: US 2004/0070300 A1
(43) Pub. Date: Apr. 15, 2004

(54) Low torque ripple surface mounted magnet synchronous motors for electric power assisted steering

(76) Inventor: Zhenxing (Zack) Fu, Ann Arbor, MI (US)

Correspondence Address: BRINKS HOFER GILSON & LIONE, P.O. BOX 10395, CHICAGO, IL, 60611, US

(21) Appl. No.: 10/268,357

(22) Filed: Oct. 10, 2002

(51) Int. Cl. H02K 21/12

(52) U.S. Cl. 310/156.47

(57) ABSTRACT

A motor having a stator and a rotor and wherein the stator has a plurality of stator poles is disclosed. Each of the plurality of stator poles is separated by a stator pole pitch. The rotor is concentrically disposed within the stator and at least one pair of magnets is mounted to the rotor. The at least one pair of magnets has at least one skewed side. Further, the rotor has a uniform variable air gap between an adjacent magnet. The magnet has inner and outer arcuate surfaces. The center of a circle describing the outside diameter of the magnet is off-centered from a circle describing an inside diameter of the magnet. Further, the at least one pair of magnets is skewed by at least one half of stator slot pitch.

### TECHNICAL FIELD

The present invention relates to AC permanent magnet synchronous motors and to devices and methods for reducing torque ripples for electric power assisted steering systems.

### BACKGROUND

In electric power assisted steering (EPAS) systems, torque ripples, which are a combination of cogging torques and harmonic torques, can adversely affect the system performance. More specifically, steering feel and the precision of torque assist may suffer.

Typically, an EPAS system includes a conventional rack and pinion steering mechanism mechanically coupled with a controlled electric actuator. Conventionally, a steering wheel is provided and coupled to an upper steering shaft, the upper steering shaft, turns a lower shaft through a universal joint. The lower steering shaft that turns the pinion gear. The rotation of the pinion gear translates to the rack which in turn actuates the tie rods. The tie rods turn a pair of steering knuckles to rotate the road wheels. Electric power steering assist is provided through a controlled electric actuator coupled to the pinion gear or the rack. The power assist actuator includes an electric motor and power electronics inverter controlled by an electronic controller. Due to the limited available package space, low power consumption, fast dynamic response and free of maintenance requirements, permanent magnet AC motors, such as brushless DC or PM synchronous motors, are typically used as the electric actuators. Generally, the power converter receives DC electrical power from a vehicle electric power source, i.e. battery, and converts it to AC power applied to the motor according to the status of a signal representative of vehicle velocity and a steering wheel angle signal. As the steering wheel is turned, the rotating angle of the steering wheel is sent to the controller. The controller, in turn, determines an appropriate amount of torque needed to assist a vehicle operator to finish the steering action via pre-tuned torque boost curves. The determined amount of torque is then used to generate Pulse Width Modulation (PWM) duty cycle signals to control the power electronics converter to supply variable frequency and variable magnitude electric power to the electric motor. The electric motor then delivers the determined torque assist to the steering mechanism.

In operation, as the rotor of the motor turns, rotor positions are detected by a position sensor mounted on the rotor or by position sensorless algorithms. The rotor position signals are then provided to the controller. In response to the vehicle velocity, operator torque on the steering wheel, steering wheel angle and rotor position signals, the controller derives desired boost torques and the corresponding PWM duty cycle commands to supply appropriate motor phase currents and thus develops the required torque. The developed torques in turn are transmitted to the steering shaft through a worm gear. Since the motor is mechanically coupled to the steering wheel via gear mechanisms, any significant vibrations produced by the motor in operation may be felt by the vehicle operator. One of the major causes for the vibrations is the torque ripple including cogging torques. Cogging torques are defined as the torque variations that result when no electrical excitation is applied, i.e. the torque produced between the magnets and the stator tooth magnetic structure. Torque ripples are defined as torque harmonics that are developed between the time and space harmonics of the stator magnetic motive force (MMF) and the space harmonics from the magnets, which rotate at asynchronous speeds.

Prior art solutions for addressing the problems stated above have been to skew the rotor magnet arcs or skew the magnetizing pattern of the rotor ring magnet by approximately a half to one full stator slot pitch. While this solution has been effective to reduce or minimize cogging torques, this solution has not been sufficient to reduce the torque ripples associated with energized torques.

Therefore, a new and improved system and method for reducing or eliminating cogging torques as well as torque ripples would be desirable. Moreover, the new and improved design and method should have a low manufacturing complexity as well as reduced costs as compared to prior art systems and methods.

### SUMMARY

A motor in accordance with the present invention includes a rotor having a plurality of magnets arranged circumferentially on the rotor surface at a constant pitch, a stator surrounding the rotor and having a plurality of stator poles, and stator windings or coils wound on the stator. In its preferred embodiment, the stator windings are sinusoidally distributed spatially along its circumference and sourced with balanced three-phase sinusoidal currents.

When the three-phase stator windings are energized, torque ripples (or torque harmonics) are created if: (a) the stator windings are not perfectly distributed sinusoidally in space, (b) three-phase currents in the stator windings are not pure sinusoidal waveform, such as those supplied by a power electronics inverter, or (c) magnetic field produced by the magnets are not a pure sinusoidal waveform in the airgap. The present invention provides a permanent magnet configuration that eliminates or greatly reduces the torque ripple. For example, the permanent magnet configuration of the present invention provides a magnetic flux field that closely matches the MMF created by the three-phase sinusoidal input currents. Thereby, torque ripples are greatly decreased by reducing the interactions among the harmonics in the MMF and the magnetic fields by the magnets.

An aspect of the present invention includes a motor having a stator and a rotor and wherein the stator has a plurality of stator poles. Each of the plurality of stator poles is separated by a stator pole pitch. The rotor is concentrically disposed within the stator and at least one pair of magnets is mounted to the rotor. The at least one pair of magnets is skewed uniformly along an axial direction. Further, the magnets on the rotor are pole-shaped to yield a uniform variable air gap along its outer surface. The magnet has inner and outer arcuate surfaces. The center of a circle describing the outside diameter of the magnet is off-centered from a circle describing an inside diameter of the magnet. The outer diameter and the amount of offsets between the centers of the inner and outer diameters are determined so as to produce a sinusoidal distribution of magnetic fields by the magnets. In one embodiment, the stator has four poles. The at least one pair of magnets is skewed by at least one half of stator slot pitch. Further, the at least one pair of magnets are pole-shaped.

These and other aspects and advantages of the present invention will become apparent upon reading the following detailed description of the invention in combination with the accompanying drawings.

### BRIEF DESCRIPTION OF THE FIGURES

FIG. 1 is an end view of a motor having a stator and rotor, wherein the rotor has permanent magnets with pole-shaping of a predefined configuration, in accordance with the present invention;

FIG. 2 is a perspective view of the rotor illustrating the skewing and pole-shaping of the magnets mounted thereto, in accordance with the present invention;

FIG. 3 is a top view of a magnet configured in accordance with the present invention;

FIG. 4 is a cross-sectional view through the magnet at a location indicated in FIG. 3;

FIG. 5 is an end view of the magnet, in accordance with the present invention;

FIG. 6 is a graph of stator MMF and magnetic flux density produced by the magnets, in accordance with the present invention; and

FIG. 7 is a graph of stator MMF and magnetic flux density produced by the magnets, in accordance with the present invention.

### DETAILED DESCRIPTION

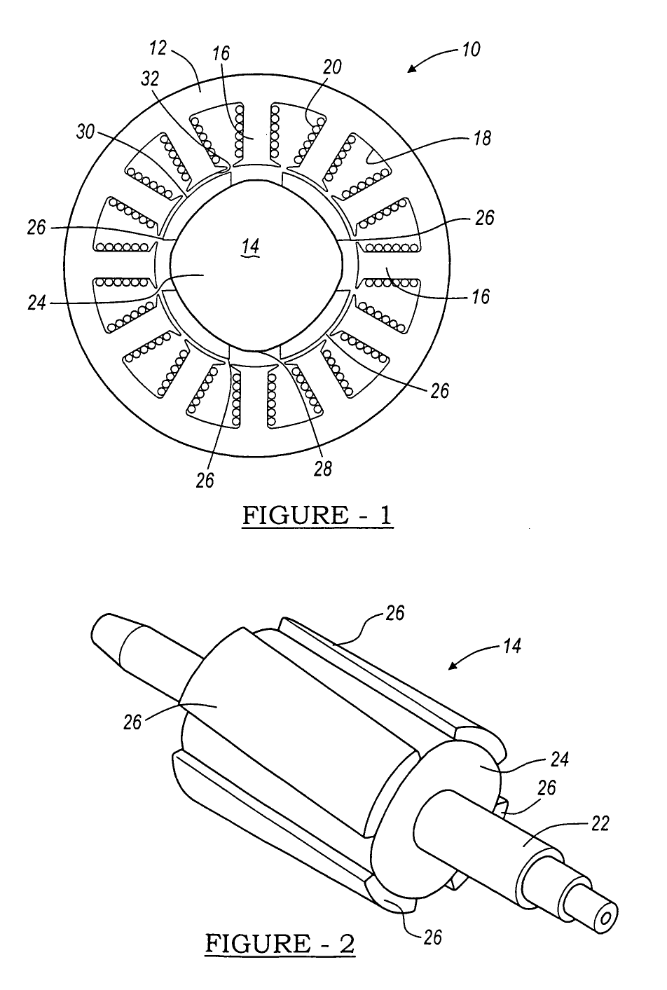

With reference to FIG. 1, an electric motor arrangement 10 is illustrated. Motor 10 may be, for example, an AC permanent magnet synchronous motor. Motor 10 includes a stator 12 and a rotor 14. As shown in FIG. 1, rotor 14 is concentric with respect to stator 12 and is disposed for rotatable movement within the stator. Generally, stator 12 includes a plurality of stator teeth 16 disposed along an inside surface 18 of stator 12 at a constant tooth pitch. Typically, the stator is comprised of a stack of laminations of magnetic material, such as low carbon steel or silicon steel. A plurality of stator windings 20 are wound and displaced inside the stator teeth 16 to generate appropriate magnetic poles similar to that on the rotor.

Rotor 14 includes a rotor shaft 22 (shown in FIG. 2), a rotor drum 24 and a plurality of permanent magnets 26. Permanent magnets 26 are mounted to a mounting surface 28 of rotor drum 24. As illustrated in FIG. 1 and FIG. 2, permanent magnets 26 are spaced a predefined distance apart on rotor drum 24. Further, a predetermined air gap is maintained between a surface 30 of each of the plurality of permanent magnets 26 and tooth surface 32 of each of the plurality of teeth 16. Thus, rotor 14 is configured for free non-contacting rotation within stator 16.

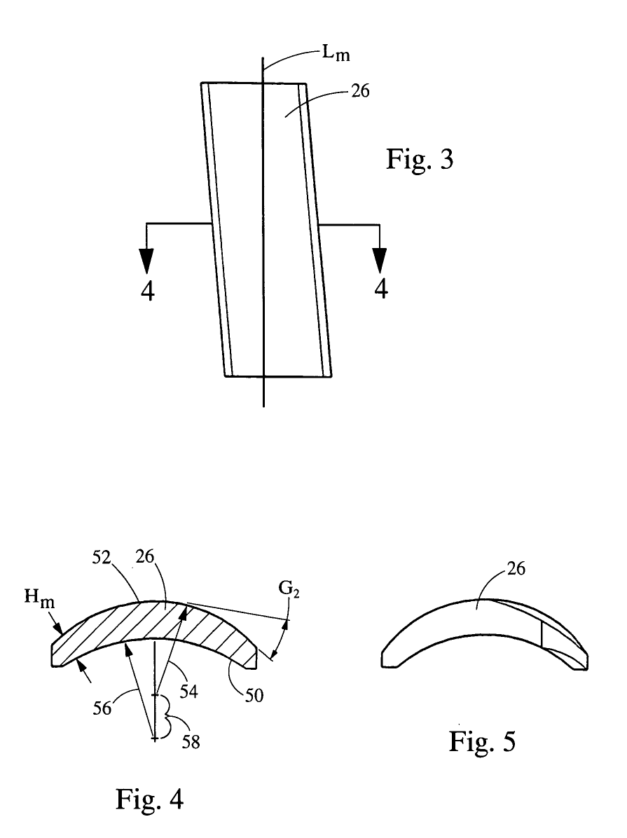

Referring now to FIG. 2, a perspective view of rotor 14 is illustrated, in accordance with the present invention. As shown permanent magnets 26 are mounted on surface 28 of rotor drum 24. The magnets are spaced at least by one stator tooth pitch. To eliminate the well known problem of cogging torque each permanent magnet 26 is skewed, as illustrated in FIG. 3. In other words, a longitudinal access lm of the permanent magnet 26 is skewed with respect to the stator teeth 16. A typical skew angle, as illustrated in FIG. 5, is approximately one slot pitch.

Another significant problem addressed by the present invention is torque ripples. The present invention reduces or eliminates torque ripples produced by the mismatch between the MMF generated by electrically energized stator windings and the magnetic flux field produced by the magnets. The present invention provides a permanent magnet 26 that is pole-shaped by having inner 50 and outer 52 arcuate surfaces and a varying magnet thickness. As illustrated in FIG. 4, permanent magnet 26 is not only skewed but also varies in thickness along its cross section. Since the outer and inner actuate surfaces are achieved by using simple geometries, having off-centered outer and inner arcs, the present invention provides a low cost manufacturing solution that achieves a near-sinusoidal magnetic field distribution in the airgap.

In order to achieve the desired magnet cross section, as illustrated in FIG. 4, the following relationship between a radius of inner surface 50 and outer surface 52 is followed.

Rₘ₀=Rₘᵢ−Hₘ−dR (1)

where:

Hₘ=the thickness of the magnet;

Rₘ₀=the outside radius 56 of the magnet;

Rₘᵢ=the inside radius 54 of the magnet, and

dR=the center offset 58 between the inside radius 54 and the outside radius 56 of the magnet.

The outside radius 56 of magnet 26 and the number of magnetic pole pairs dictate the magnetic pole pitch, as given by the relationship:

$${α}_{p} = \frac{2 π R m0}{2 P} \qquad ( 2 )$$

Given these relationships the center offset 58 between the inside radius 54 and the outside radius 56 of permanent magnet 26 is given by the following relationship:

$$d R = \frac{2 {G}_{2} ( {R}_{m i} + {H}_{m} ) - {G}_{2}^{2}}{2 [ {R}_{m i} + {H}_{m} - ( {R}_{m i} + {H}_{m} - {G}_{2} ) cos ( {α}_{p} \frac{π}{P} ) ]} \qquad ( 3 )$$

where:

G₂=the gap between the end of the magnet and the air gap between the stator and rotor;

Hₘ=the thickness of the magnet;

Rₘᵢ=the inside radius of the magnet;

αₚ=the magnet pole pitch;

P=the number of magnet pole pairs.

The skew angle for reducing cogging torque may be determined by the following relationship

$$skew angle = \frac{180}{π} {tan}^{- 1} ( \frac{{τ}_{s}}{{L}_{s t}} ) ;$$

and where the stator tooth pitch,

$${τ}_{s} = \frac{2 π {R}_{s t}}{{Z}_{s}} and$$

where:

Rₛₜ=stator inside radius; and

Lₛₜ=axial length of stator lamination stock;

Zₛ=number of stator teeth.

Moreover, G₂ is determined by numerical magnetic filed analysis using finite element methods (FEM). More specifically, G₂ is altered until the magnet flux field generated by the permanent magnets 26 substantially matches the sinusoidal distribution in the airgap.

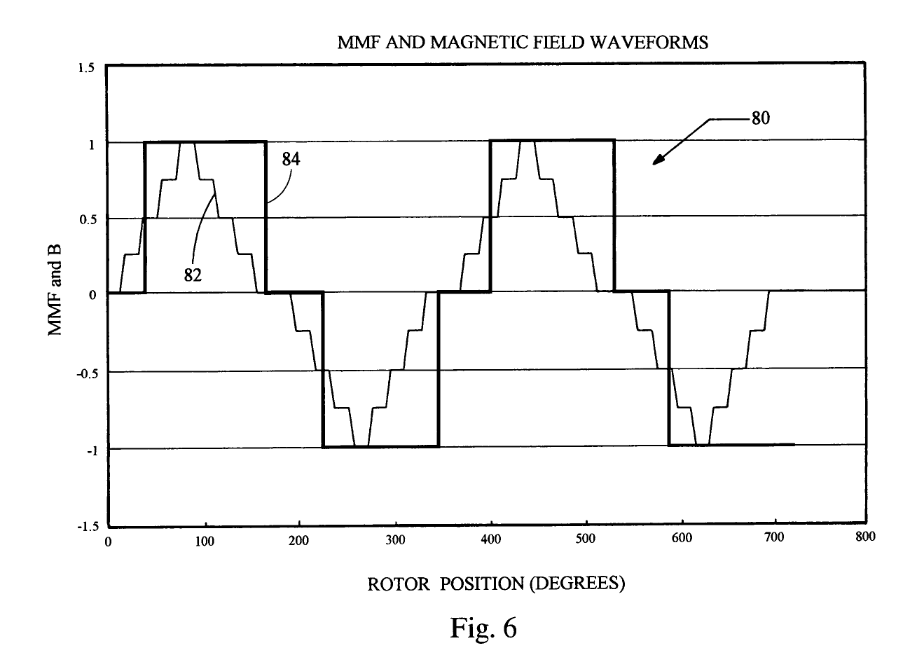

With reference to FIGS. 6, time charts 80 of typical waveforms of MMF 82, produced by a three-phase sinusoidal input current supplied to the stator windings, and profiles of the magnetic flux density 84 generated by the permanent magnets without pole-shaping, as in prior art, are shown. The resultant MMF 82 produced by three-phase sinusoidal currents in the stator windings is represented by line 82 and the magnetic flux density generated by permanent magnets is represented by line 84. From Fourier series analysis, the resultant waveform 82 may be expanded into a summation of harmonics by:

$$MMF\_t = \frac{4}{π} ( \frac{3 \sqrt{2 N I q}}{2} ) {\sum }_{n = 1} \frac{1}{n} {K}_{n w} cos ( n θ \pm ω t ) ; n = 1 , 5 , 7 , 11 , 13 … ;$$

where: N=number of turns per phase;

I=RMS value of phase current;

q=number of slot per pole per phase;

Knw=winding factor for nth order harmonics; and

ω=electrical Radians/sec.

The magnetic field 84 produced by the magnets can be represented by:

$$B ( θ ) = \frac{4 B}{π} {\sum }_{n = 1} \frac{1}{n} cos ( n ( θ - α ) ) ; n = 1 , 3 , 5 , 7 , 9 …$$

From Lorentz law, the torque developed in the motor may be calculated by:

$${T}_{e} = - p {\int }_{0}^{π / p} 2 r l B ( θ ) MMF\_t ⅆ θ$$

where: r=radius of stator inside diameter;

p=number of poles; and

l=effective axial length of stator.

From the above equations, the torque developed contains harmonics, since both MMF _t and B(θ) contain rich harmonics. If a particular order of torque harmonics rotates at synchronous speed, the corresponding torque harmonic contributes to average torque. Conversely, if a particular order of torque harmonics rotates at asynchronous speeds, the corresponding torque harmonic becomes torque ripple. Since the waveform 84 of the magnetic fields produced by the magnets without pole-shaping are similar to a square waveform as shown in FIG. 6, the torque ripples of the motor are high.

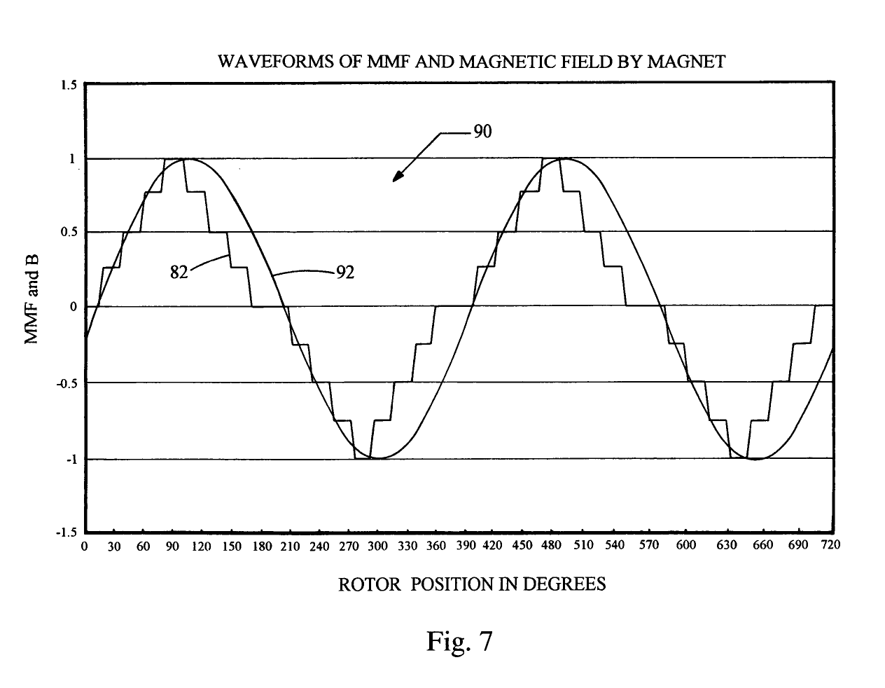

FIG. 7 illustrates time charts 90 of waveforms of MMF 82 and of magnetic fields 92 produced by a motor having magnets that have undergone pole-shaping in accordance with the present invention. Using numerical magnetic field analysis, such as FEM, a proper outer radius of the magnet 26 and the amount of off-center may be determined in order to produce magnetic fields near sinusoidal distribution (such as waveform 92). Thus, the torque ripples associated with such an improved motor are much reduced.

The present invention has many advantages and benefits over the prior art. For example, the present invention reduces harmonic or ripple torques by forming the permanent magnet into a simple geometrical shape according to a predefined relationship. Advantageously, no secondary forming operations, such as grinding, are necessary to achieve the desired magnet shape. Accordingly, the present invention is less costly than prior art methods and devices. Moreover, the present invention is especially suitable for actuators used in EPAS systems where even small torque disturbances are felt by a vehicle operator.

As any person skilled in the art of brushless DC motors or AC permanent magnet synchronous motors and to those devices and methods for reducing torque ripples will recognize from the previous detailed description and from the figures and claims, modifications and changes can be made to the preferred embodiments of the invention without departing from the scope of this invention defined in the following claims.

1. A motor, comprising:
a stator having a plurality of stator poles wherein each of the plurality of poles is separated by a stator pole pitch;
a rotor wherein the rotor is concentrically disposed within the stator; and
a magnet mounted to the rotor, the magnet being pole shaped and having a skewed sides.

2. The motor of claim 1 wherein the rotor has a uniform variable air gap along an outer surface of the magnet.

3. The motor of claim 1 where the magnet has an inner and an outer actuate surface.

4. The motor of claim 1 wherein an outside diameter of the magnet is off-centered from an inside diameter of the magnet.

5. The motor of claim 1 wherein the stator has four poles.

6. The motor of claim 1 wherein the magnet is skewed by at least one-half of a stator slot pitch.

7. A method for shaping a magnetic field emanating from a permanent magnet, wherein the permanent magnet is fixed to a rotor, the rotor being concentrically positioned within a stator of an electric machine and wherein an air gap exists between the permanent magnet and the stator, the method comprising:
forming an arcuate outer surface in the permanent magnet that generates the magnetic field;
forming an arcuate inner surface in the permanent magnet; and
varying a thickness of the magnet between the outer and inner surfaces of the magnet.

8. The method of claim 7 wherein forming an arcuate outer surface further comprises forming an arcuate outer surface that has a radius that is smaller than a radius of the arcuate inner surface.

9. The method of claim 7 forming an arcuate inner surface further comprises forming an arcuate inner surface that has a radius that is larger than a radius of the arcuate outer surface.

10. The method of claim 7 wherein varying a thickness of the magnet further comprises offsetting a center of a circle defining the arcuate inner surface from a center of a circle defining the arcuate outer surface.

11. The method of claim 7 further comprising skewing the magnet.

12. The method of claim 7 further comprising changing the air gap between an end of the permanent magnet and the stator until the magnetic field substantially matches an input current waveform corresponding an input current to a winding of the stator.
